(19) United States
(12) Patent Application Publication
(10) Pub. No.: US 2014/0288296 A1
(43) Pub. Date: Sep. 25, 2014

(54) CELLULOSE FILMS WITH AT LEAST ONE HYDROPHOBIC OR LESS HYDROPHILIC SURFACE

(71) Applicant: FPINNOVATIONS, Pointe-Claire (CA)

(72) Inventors: Hao QI, Vancouver (CA); Thomas Qiuxiong HU, Vancouver (CA); Gilles DORRIS, Vimont Laval (CA)

(21) Appl. No.: 14/223,030

(22) Filed: Mar. 24, 2014

Related U.S. Application Data
(60) Provisional application No. 61/804,897, filed on Mar. 25, 2013.
(60) Provisional application No. 61/833,190, filed on Jun. 10, 2013.

(51) Int. Cl. C08J 5/18; C08L 1/02

(52) U.S. Cl. CPC C08J 5/18; C08L 1/02; C08J 2301/02
USPC 536/56; 264/299; 264/101

(57) ABSTRACT

A method for the production of cellulose films with at least one hydrophobic or less hydrophilic surface, or with at least one surface with a water contact angle (θ) in a range from 55° to less than 100° is described. The method involves contacting the cellulose material with a hydrophobic solid material during the preparation of the cellulose films or with a vapour of a non-polar or polar aprotic solvent during or after the preparation of the cellulose films. Examples of the cellulose material are cellulose filaments (CF) made to have at least 50% by weight of the filaments having a filament length up to 350 μm and a filament diameter between 100 and 500 nm from multi-pass, high consistency refining of wood or plant fibers, and commercially-available sodium carboxymethyl cellulose. Examples of the hydrophobic solid material are hydrophobic polymers, poly(methylpentene) and poly(ethylene). Examples of the non-polar solvent are hexane and toluene. Examples of the polar aprotic solvent are acetone and ethyl acetate.

### BACKGROUND OF THE INVENTION

i) Field of the Invention

This invention relates to the production of cellulose films with controllable hydrophobicity or hydrophilicity. In particular, it relates to the production of cellulose films with at least one hydrophobic or less hydrophilic surface.

ii) Description of the Prior Art

Cellulose is the most abundant biopolymer on earth. It is the main component of higher plant cell walls, and it is also formed by some algae, fungi, bacterial, and a group of invertebrate marine animals, the tunicates. Native cellulose and cellulose from pulping of lignocellulosic materials is fibrous and consists of crystalline and amorphous domains of 1,4-linked β-D-glucose.

Within the cell walls of bleached kraft pulp fibers produced from kraft pulping of lignocellulosic materials are cellulose microfibrils of several micron (μm) in lengths and 1-50 nanometer (nm) in diameters. Cellulose microfibrils, referred to as microfibrillated cellulose (MFC), can be produced by repeated mechanical disintegration of cellulose pulp fibers under high pressure (800 psi) at 70-80° C. in a small commercial homogenizer [Turbak et al. J. Appl. Polym. Sci.: Appl. Polym. Symp. 37: 815-827 (1983).]. They can also be produced by mechanical disintegration of cellulose pulp fibres using common apparatus such as disc refiners used in the manufacturing of mechanical wood pulp fibres [See US Pat. No. 7,381,294B2]. The energy consumption needed for the preparation of MFC can be reduced by various pretreatment processes such as 2,2,6,6-tetramethylpiperidinyl-1-oxy (TEMPO)-mediated oxidation and enzymatic hydrolysis [Saito et al. Biomacromolecules 7(6):1687-1691 (2006) and Henriksson et al. European Polym. J. 43(8): 3434-3441 (2007)]. The term, nanofibrillated cellulose (NFC), cellulose nanofibers or nanocellulose [Zimmermann et al. Carbohydr. Polym. 79: 1086-1093 (2010); Abe et al. Biomacromolecules 8: 3276-3278 (2007) and Vartiainen et al. Cellulose DOI 10.1007/s10570-011-9501-7 (2011)] has also been used to describe MFC or other fibrillated cellulose materials obtained with mechanical disintegration of cellulose pulp fibers as one of the key processing steps because the diameters of the fibrillated cellulose materials are typically 100 nm. These materials typically have an aspect ratio (length over diameter) of less than 100.

A novel family of fibrillated cellulose materials, referred to previously as cellulose nanofilaments (CNF) and herein as cellulose filaments (CF), have recently been isolated from multi-pass, high consistency refining of plant or wood fibres such as northern bleached softwood kraft (NBSK) pulp fibres [Hua et al. PCT/CA2012/000060; WO 2012/097446 A1 (2012)].

Films such as cast films made from MFC have been shown to be strong and to have low air permeability and low oxygen transmission rate that are required for use in atmosphere packaging [Syverud and Stenius Cellulose 16: 75-85 (2009)]. However, films made from MFC, similar to those made from other cellulose materials such as nanocrystalline cellulose (NCC) prepared from sulphuric acid hydrolysis of cotton fibers or bleached kraft pulp fibers or regenerated cellulose prepared from bleached sulfite pulp fibers, are hydrophilic and have high water absorption. The water contact angle of MFC cast film has been reported to be 28±4° [Andresen et al Cellulose 13: 665-677 (2006)] as well as 41.2° [Rodionova et al Cellulose 18: 127-134 (2011) and Rodionova et al Proc. 2010 Tappi Intl. Conf. on Nanotechnol. for Forest Product Industry (2010)], while the water contact angle of NCC cast film has been reported to be 17.8±1.1° [Dankovich and Gray J. Adhes. Sci. Technol. 25: 699-708 (2011)]. Water contact angle (θ) is a parameter used widely in determining the hydrophilicity and wettability of a solid surface. The lower the θ value, the higher the hydrophilicity (and thus the lower the hydrophobicity) of a surface; with θ value of <90° (more typically θ≦30°) representing a hydrophilic surface, θ=90-120° representing a hydrophobic surface, and θ≧150° representing a super-hydrophobic surface.

The hydrophilicity of films from MFC, NCC and regenerated cellulose and of cellulose pulp fibres is due mainly to the presence of three hydroxyl (—OH) groups per repeating anhydroglucose (C₆H₁₀O₅) unit in the cellulose molecular chain. Many approaches to chemically modify the cellulose —OH group to improve the hydrophobicity of cellulose pulp fibres have been attempted by many researchers over the last 25 years. Recently, silylation or acetylation of solvent-exchanged MFC in organic solvents before film preparation [See references by Andresen et al. and by Rodionova et al. (2011)] and gas-phase esterification of MFC cast films [See reference by Rodionova et al. (2010)] have been reported. Although silylation of the —OH groups on MFC leads to an increase of water contact angle (θ) of the MFC film from 28±4° to up to 146±8°, it requires the removal of water from MFC by solvent exchange before the silylation and the use of organic solvents for the reaction. Liquid-phase acetylation of the solvent-exchanged MFC with acetic anhydride in toluene before film preparation only increases θ value of the MFC films from 41.2° to a maximum of 82.7±5.8°. Gas-phase esterification of MFC cast-films with acetic acid and trifluoroacetic anhydride only increases θ value of the MFC film from 41.2° to a maximum of 79.2±2.9°.

Films of regenerated cellulose such as cellophane and cuprophane have an θ value of about 12° which is lower than the θ values of MFC, NCC or many of the widely used synthetic polymers such as poly(vinyl alcohol), 36° and poly(methyl methacrylate), 57°. Recent experimental data and theoretical calculations, however, have indicated that cellulose including regenerated cellulose has a hydrophobic property due to its structural anisotropy [Yamane et al. Polym J. 38(8): 819-826 (2006) and Mazeau and Rivet Biomacromolecules 9: 1352-1354 (2008)]. The equatorial direction of the cellulose glucopyranose ring is hydrophilic because all three hydroxyl (—OH) groups on the ring are located on the equatorial positions of the ring, while the axial direction of the ring is hydrophobic because of hydrogen atoms of C—H bonds being located on the axial positions. Treatments of cellophane film with cyclohexane at 25° C., liquid ammonia at −80° C. and glycerine at 260° C. increase θ value of the film from 11.6° to 14.6°, 39.6° and 24.0°, respectively. The increase of the contact angle achieved through the solvent treatments has been suggested to be due to the re-orientation of a more hydrophilic cellulose crystal plane to less hydrophilic cellulose crystal planes on the surface of the films.

Prior to the present invention, however, no cellulose film with a less hydrophilic surface (50°≦θ<90°) or hydrophobic surface (θ≧90°) has been produced by physical methods without the use of any chemical reagents or organic solvents, or by treatment with vapour of an organic solvent. In addition, no cellulose film with two surfaces different and yet controllable in hydrophobicity has been produced by any methods.

### SUMMARY OF THE INVENTION

It has now been discovered that cellulose film with at least one hydrophobic or less hydrophilic surface can be produced by, for example, casting a stable water suspension of a cellulose material onto a hydrophobic solid support material and by evaporating the water.

It has also been discovered that cellulose film with at least one hydrophobic or less hydrophilic surface can be produced by contacting the film made from a stable water suspension of a cellulose material during the filtration dewatering, pressing and/or drying of the film with a hydrophobic solid material.

Furthermore, it has been discovered that cellulose film with at least one hydrophobic or one less hydrophilic surface can be produced by treating the film during or after the drying of the film with vapour of a non-polar or polar aprotic solvent that is not reactive towards cellulosic material. The vapor treatment is free of any chemical reagent such as acetic anhydride that is known to be reactive towards cellulosic material.

The films of the present invention can be used to produce packaging materials with low air permeability and low oxygen transmission rate, and with high water contact angle.

In accordance with one aspect of the present invention, there is provided a cellulose film comprising a cellulose filament material free of chemical modification, wherein the film comprises at least one surface with a water contact angle θ with a value in a range from 55° to 100°.

In accordance with one aspect of the film herein described, the cellulose filament material derives from a dispersed aqueous suspension of cellulose filaments from a multi-pass, high consistency refining of plant or wood fibres such as northern bleached softwood kraft (NBSK) pulp fibres and/or a thermo mechanical pulp (TMP).

In accordance with another aspect of the cellulose film herein described, the value of the water contact angle θ is from 60° to 100°.

In accordance with yet another aspect of the cellulose film herein described, the value of the water contact angle θ is from 70° to less than 90°.

In accordance with still another aspect of the cellulose film herein described, the value of the water contact angle θ is from 80° to less than 90°.

In accordance with yet still another aspect of the cellulose film herein described, the value of the water contact angle θ is from 85° to less than 90°.

In accordance with another aspect of the present invention, there is provided a method of producing a cellulose film with at least one surface with a water contact angle (θ) in a range from 55° to 100°, the method comprising: providing an aqueous cellulose filament suspension free of chemical modification, contacting the suspension onto a hydrophobic support material to produce the film; and removing water from the film.

In accordance with a further aspect of the method herein described, the hydrophobic support material is a polymer made from at least one of an unsubstituted or substituted alkene of formula R₁—CH═CH—R₂, wherein R₁ and R₂ are independently hydrogen (H), unsubstituted or substituted C1-C12 alkyl group, or unsubstituted or substituted C6-C14 aryl group.

In accordance with yet a further aspect of the method herein described, the hydrophobic support material is a hydrophobic polymer of ethylene-, CH₂═CH₂, selected from the group consisting of poly(ethylene) (PE), low-density poly(ethylene) (LDPE), high-density poly(ethylene) (HDPE), ultra-low-density poly(ethylene) (ULDPE) and combinations thereof.

In accordance with still another aspect of the method herein described, the hydrophobic support material is a hydrophobic polymer of propylene, CH₂═CHCH₃ or 4-methyl-1-pentene, CH₂═CHCH₂CH(CH₃)₂, or a co-polymer of two to three of alkenes selected from ethylene, propylene and 4-methyl-1-pentene. Wherein the polymer of 4-methyl-1-pentene is commonly referred to as poly(methylpentene) (PMP).

In accordance with yet still another aspect of the method herein described, further comprising a vapour treatment with a non-polar or polar aprotic solvent.

In accordance with one embodiment of the method herein described, the non-polar solvent is at least one of toluene and hexane.

In accordance with one embodiment of the method herein described, the polar aprotic solvent is at least one of acetone and ethyl acetate.

In accordance with another embodiment of the method herein described, the suspension comprises a concentration of cellulose filaments in the range of 0.001% to 10.0%.

In accordance with yet another embodiment of the method herein described, the concentration of cellulose filaments is in the range of 0.005% to 5.0%.

In accordance with still another embodiment of the method herein described, the concentration of cellulose filaments is in the range of 0.01% to 2.0%.

In accordance with yet still another embodiment of the method herein described, the suspension further comprises additives for pH and/or conductivity control.

In accordance with a further embodiment of the method herein described, the additives further comprise water-soluble compounds or water-soluble polymers selected from the group consisting of poly(methacrylic) acid and/or poly(methacrylate) sodium salt.

In accordance with yet a further embodiment of the method herein described, the additives have a concentration in the range of 0.0% to 10.0 wt % of the cellulose filaments.

In accordance with still a further embodiment of the method herein described, the removing water from the film is by evaporating the water at ambient temperature (20° C.) or at a higher temperature (>20° C. and ≦100 ° C.) with or without vacuum.

In accordance with yet still a further embodiment of the method herein described, removing the water from the film is by contacting the suspension with a permeable hydrophobic solid support material.

In accordance with yet another embodiment of the method herein described, the aqueous cellulose filament suspension free of chemical modification is from a multi-pass, high consistency refining of a northern bleached softwood kraft (NBSK) pulp and/or a thermo mechanical pulp (TMP).

### DESCRIPTION OF THE DRAWINGS

FIG. 1—Shape of water droplets on the surface of a) the bottom side, and b) the top side of a film formed from a water suspension of cellulose filaments on a poly(methylpentene) (PMP) solid support material; c) the bottom side, and d) the top side of a film formed from a water suspension of cellulose filaments on a glass solid support material.

FIG. 2—Time dependence of the water contact angle on the surface of the bottom side of a film formed from a water suspension of cellulose filaments on a poly(methylpentene) (PMP) solid support material (▪) and on a glass solid support material (▴), respectively. Error bars show the standard deviations.

### DETAILED DESCRIPTION OF THE INVENTION

Films such as cast films made from a stable water suspension of cellulose materials such as MFC, NCC and regenerated cellulose have high water absorption and low water contact angles because of the abundance of the hydrophilic cellulose hydroxyl (—OH) groups on the surface of the films. Although chemical modification of these hydrophilic groups before or after film forming increases the water contact angles and lowers the water absorption, it requires a complicated solvent exchange process prior to the modification or it gives a limited increase in the water contact angles. In addition, no method has been reported in the literature to produce films with one hydrophobic or less hydrophilic surface and one hydrophilic surface from any cellulose materials.

According to one aspect of the present invention, films made from a stable water suspension of cellulose materials with one hydrophobic or less hydrophilic surface and one hydrophilic surface can be prepared by casting the suspension on a hydrophobic solid support material and by evaporating the water.

According to another aspect of the present invention, films made from a stable water suspension of cellulose materials with one hydrophobic or less hydrophilic surface and one hydrophilic surface can be prepared by forming a film of cellulose material with high solid-content using apparatus commonly used for the dewatering of pulp fibre slurry in paper and sheet making, and then by contacting the said high solid-content film with a hydrophobic solid material and by further pressing and/or drying of the film.

According to yet another aspect of the present invention, films made from a stable water suspension of the cellulose materials with at least one hydrophobic or less hydrophilic surface can be prepared by contacting the film during or after the drying of the film with vapour of a non-polar or polar aprotic solvent.

The improvement in the hydrophobicity of one or two sides of the said films prepared according to the present invention depends on the cellulose material, the hydrophobic solid support material or the hydrophobic solid material, the solvent, the concentration of the cellulose material and chemical additives in the said suspension, the water removal and film forming process. The cellulose material is preferably cellulose filaments (CF) prepared by multi-pass, high consistency refining (operating at a low refining intensity) of plant or wood pulp fibres. One family of the hydrophobic solid support material or the hydrophobic solid material is a hydrophobic polymer made from, for example, an un-substituted or substituted alkene, —CH₂═CHR where R is hydrogen, an alkyl or substituted alkyl, aryl or substituted aryl. Examples of the said hydrophobic polymers are poly(ethylene) (PE), poly(methylpentene) (PMP), and poly(propylene) (PP) made from ethylene, CH₂═CH₂, 4-methyl-1-pentene, CH₂═CHCH₂CH(CH₃)₂, and propylene, CH₂═CHCH₃ respectively. The solvent is preferably a non-polar or polar aprotic solvent such as hexane and toluene or acetone and ethyl acetate. The concentration of the cellulose material in the said stable water suspension is preferably in the range of 0.001% to 10.0%, more preferably in the range of 0.005% to 5.0%, and most preferably in the range of 0.01% to 2.0%. The chemical additives in the said stable water suspension can be those used for controlling the pH and/or the conductivity of the suspension such as sulphuric or hydrochloric acid, sodium hydroxide and/or sodium chloride. They can also be any other water-soluble compounds or water-soluble polymers such as poly(methacrylic acid, sodium salt) that can impart other desirable properties to the films. The concentration of these additives can be in the range of 0.0% to 10.0% of the cellulose material used. The removal of water and formation of the said film can be achieved by casting of the said suspension onto the said hydrophobic solid support material that is not permeable to water and then by evaporating the water at ambient temperature (20° C.) or at a higher temperature (>20° C. and ≦100° C.) without or with the application of vacuum. They can also be achieved by contacting the suspension with the said hydrophobic solid support material that is permeable to water and then by both filtration and evaporation of the water using processes commonly employed for making sheets and papers. They can also be achieved by forming a film from the said suspension and then by contacting the film with a hydrophobic solid material during pressing and/or drying of the film. The solvent treatment is done generally without directly contacting the film with solvent liquid, but by contacting the film with solvent vapour. The vapour of the solvent is produced by heating the solvent to its boiling point, or to near or above its boiling point (if the solvent is in a pressurized vessel). The contact step will depend on the boiling point of the solvent and the surrounding environmental pressure, the treatment can be done at a temperature of 35 to 250° C. in a closed or an open system, preferably at a temperature of 60 to 220° C. in a closed or an open system.

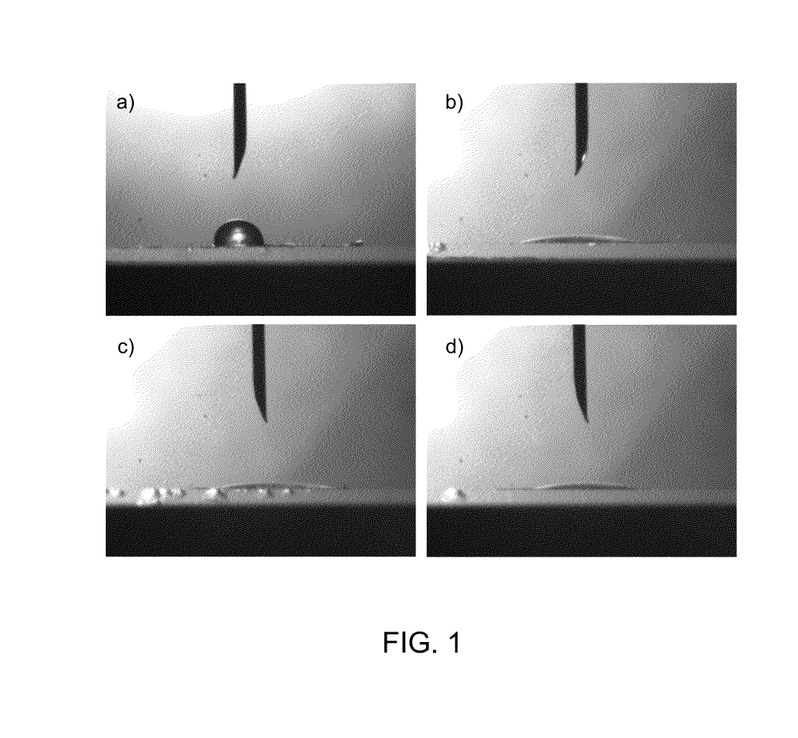

FIG. 1 a) and b) show the pictures of water droplets placed on the surface of the bottom side and on the surface of the top side of a film formed from casting of 0.05% of a stable CF water suspension on a PMP solid support material and evaporating the water at ambient temperature according to the current invention. The water contact angles (and standard deviations) of the bottom side and the top side of the film are θ=85.4±6.0°, and θ=14.0±0.8°, respectively. The difference in the hydrophobicity of the two sides (surfaces) of the film, as represented by the difference in their water contact angles, is 71.4°. It is possible that PMP, when comes into contact with the cellulose filaments during the preparation of the film, is capable of inducing the re-orientation of the cellulose molecular chains to expose the more hydrophobic C—H moieties on the film surface that is in contact with PMP. However, other mechanisms may also contribute to or be responsible for the ability of PMP to induce the formation of a cellulose film with a less hydrophilic or hydrophobic surface.

Cellulose material in the present invention refers to any cellulose material that forms a stable water suspension. It includes, but is not limited to, cellulose filaments (CF) prepared by multi-pass, high consistency refining of plant or wood fibres such as northern bleached softwood kraft (NBSK) pulp fibres, and commercially-available cellulose derivatives such as sodium carboxymethylcellulose. The cellulose material may also derive from thermo mechanical pulps (TMPs) alone or in combination with NBSK and/or carboxymethlycellulose.

The stable cellulose suspension is understood to have the following properties: is a dispersed suspension having the being dispersed throughout the aqueous phase by mechanical agitation and to remain well-dispersed for a long period of time, up to several days or hours. The stability of the suspension depending on the concentration of the suspension and the extent of mechanical agitation. The stable dispersion is generally prepared prior to film preparation.

The expression free of chemical modification is understood to mean that no formation of new covalent chemical bonds occurs in the cellulose material during the production of the cellulose film with at least one hydrophobic or less hydrophilic surface. The cellulose filaments material of the present invention is not modified by, for example, liquid-phase silylation that may be preceded by solvent exchange to remove water from a cellulose raw material, or gas-phase acetylation with acetic acid and trifluoroacetic acid that may be preceded by solvent exchange to remove water. Thus, the cellulose materials in the cellulose films of the present invention are free of silyl group, acetyl groups and other hydrophobic chemical groups introduced to the cellulose materials by chemical modification.

The solvent vapour treatment of the cellulose film is done without directly contacting the film with the liquid form of the solvent. It is done by contacting the film with the vapour of the solvent, that does not react to produce chemical bonds with the cellulose; i.e. is free of solvent/cellulose bonds. The vapour of the solvent is produced by heating the solvent to its boiling point or near or above its boiling point. Depending on the boiling point of the solvent and the surrounding environmental pressure, the treatment can be done at a temperature of 35 to 250° C. in a closed or an open system such as a closed reactor or an open vessel, preferably at a temperature of 60 to 220° C. in a closed or an open system such as a closed reactor or an open vessel. The pressure inside a closed system can be 10 to 1000 psi, preferably 10 to 500 psi, more preferably 10 to 200 psi, and most preferably 10 to 100 psi. The treatment time can be several seconds to several hours, more preferably 30 seconds to one hour, and most preferably 1 to 30 minutes. The solvent is any non-polar or polar aprotic solvent with a boiling point (at atmospheric pressure) of 35 to 200° C., preferably of 40 to 180° C., more preferably of 50 to 150° C., and most preferably 60 to 120° C.

Non-polar solvents include and are not limited to: hexane, pentane, cyclohexane, cyclopentane and toluene.

Polar, aprotic solvents include and are not limited to: acetone, ethyl acetate, acetonitrile, tetrahydrofuran and dichloromethane.

Cellulose film in the present invention refers to film made from the cellulose material specified in the present invention. It can be made by casting the suspension of cellulose material onto a solid support material, evaporating the water and then separating the film from the support material. It can also be formed from a suspension of the cellulose material by filtration, pressing and drying using apparatus commonly used for the production of papers, tissues or paperboards.

Hydrophobic solid support material or hydrophobic solid material in the present invention refers to a solid material that is capable of inducing the formation of a cellulose film with one hydrophobic or less hydrophilic surface and is not permeable to water such as poly(methylpentene) (PMP) in the form of a beaker, a sheet or any other shapes. It also refers to a solid material that is capable of inducing the formation of a cellulose film with one hydrophobic or less hydrophilic surface, and is permeable to water but is able to retain the cellulose material. It includes, but is not limited to, a hydrophobic polymer such as PMP, a hydrophobic press felt, forming or dryer fabric that can be used on a conventional or modified tissue, paper or paperboard machine, and a hydrophobic press or drying roll that can be used on a conventional or modified tissue, paper or paperboard machine.

The bottom side (surface) of a film in the present invention refers to the side (surface) that comes into contact with the said solid support material during the preparation of the said cellulose film. The top side (surface) of a film in the present invention refers to the side (surface) that does not come into contact with the said solid support material and that usually comes into contact with air.

Consistency in the present invention is defined as the weight percentage of a cellulose material in a cellulose material and water mixture.

A hydrophilic surface of a cellulosic film is defined here as a surface with water contact angles (θ) of less than 50°.

A less hydrophilic surface of a cellulosic film is defined here as a surface with water contact angles (θ) of 50° to less than 90°.

A hydrophobic surface of a cellulosic film is defined here as a surface with water contact angle (θ) of 90° or more than 90°.

The present invention is illustrated by, but not limited to, the following examples.

### GENERAL PROCEDURE A EMPLOYED IN THE EXAMPLES: PREPARATION OF A CAST FILM FROM A STABLE WATER SUSPENSION OF A CELLULOSE MATERIAL

Unless otherwise specified, a known concentration of a stable water suspension of cellulose filaments (CF) with at least 50% by weight of the filaments having a filament length up to 350 μm and a filament diameter between 100 and 500 nm prepared from multi-pass, high consistency refining (operating at a low refining intensity) of a northern bleached softwood kraft (NBSK) pulp fibres was drop-casted onto a hydrophobic solid support material. The water was allowed to evaporate at room temperature (˜20° C.) to give a dry film which was then separated from the solid support material. The basic weight of the film was determined from the amount of the CF used and the area of the film.

### GENERAL PROCEDURE B EMPLOYED IN THE EXAMPLES: PREPARATION OF A CF FILM FROM A STABLE CF WATER SUSPENSION BY FILTRATION, PRESSING AND DRYING

Unless otherwise specified, a CF film was prepared using a modified PAPTAC Test Method, Standard C5 as follows. A know amount of distilled water was first poured into a British Sheet Maker. A known concentration of CF suspension was disintegrated for 1-2 minutes until no obvious fibre bundles were seen. The disintegrated suspension was transferred carefully (without any splashing) into the Sheet Machine using a Teflon spoon. The CF suspension inside the Sheet Machine was gently stirred back and forth across the deckle using a Teflon stick and was then allowed to become still. The drain valve of the Sheet Machine was slowly released to allow the dripping of water and closed when the water had drained out from the deckle and a CF film had been formed on top of the steel mesh.

The deckle was opened and one Whatman filter paper (185 mm in diameter) was placed on top of the wet CF film. Two blotters were placed on top of the filter paper and couching was applied using a couch plate and a couch roll. 20 traverses backwards and forwards were applied before the couch plate and the two blotters were carefully removed. The filter paper with the CF film stuck to it was then slowly peeled off from the steel mesh.

Pressing of the CF film was then performed according to the pressing procedure described in PAPTAC Test Method, Standard C.5 with the first and secondary pressing for 5.5 and 2.5 minutes, respectively. A mirror-polished stainless steel disc was placed against the side of CF film that was not adhered to the filter paper during the pressing.

After the pressing, the CF film which was sandwiched between the filter paper and the steel plate was dried in a Constant Temperature (23° C.) and Humidity (50%) (CTH) room overnight. The CF film was then carefully peeled off from the steel plate, and carefully separated, by peeling off back and forth several times, from the filter paper.

### GENERAL PROCEDURE C EMPLOYED IN THE EXAMPLES: MEASUREMENT OF WATER CONTACT ANGLE

Water contact angle measurement of a film made from a stable water suspension of a cellulose material according to General Procedure A or a film made from a stable CF water suspension according to General Procedure B was performed following the ASTM Standard D 724-99 Standard Test Method for Surface Wettablility of Paper (Angle-of-Contact Method) on a contact angle goniometer (SCI-Contact-02). A small piece (10 mm×15 mm) of the film was stuck to a glass slide using two-sided tape. A droplet of deionized water (˜5.0-6.7 4) was dropped onto the film from a standard distance (3.3 mm) and an image of the droplet was taken, unless otherwise specified, immediately. Same experiments were performed on two or three additional different spots of the same piece of the film. An average value of the water contact angles and the corresponding standard deviation were then calculated and reported.

### EXAMPLE 1

20 ml of 0.05% CF suspension was drop-casted, according to General Procedure disclosed above, onto a plastic beaker made of poly(methylpentene) (PMP) to give, after evaporation of the water at ˜20° C., a dry film with a basic weight of 5.0 g/m².

FIG. 1 a) shows the snapshot (picture) of the water droplet dropped onto the bottom side (surface) of the film. FIG. 1 b) shows the picture of the water droplet dropped onto the top side (surface) of the film. The average water contact angle and the standard deviation of the bottom side of the film is 85.4±6.0°. The average water contact angle and the standard deviation of the top side of the film is 14.0±0.8°. The difference in the water contact angles of the bottom and the top sides of the film formed using PMP as the solid support material is 71.4°.

In a separate experiment, a Glass Petri dish was cleaned with a mixture of 3:1 (v/v) concentrated sulfuric acid and 30% hydrogen peroxide and then thoroughly washed with deionized water. 20 ml of 0.05% CF suspension was drop-casted onto the cleaned Glass Petri dish to give, after evaporation of the water at ˜20° C., a dry film on the Glass Petri dish with a basic weight of 1.6 g/m². The average water contact angles and the standard deviations of the bottom side and the top side of the film formed using the Glass Petri dish as the solid support are 14.8±2.9° and 15.2±1.0°, respectively. As can be seen from the data, there is no statistical difference in the water contact angles between the bottom side and the top side of the film formed using Glass Petri dish as the solid support material.

The above data clearly show that PMP is capable of inducing the formation of a cellulose film with one less hydrophilic surface and one hydrophilic surface.

### EXAMPLE 2

10 ml of 0.02% CF suspension was drop-casted, according to General Procedure A disclosed above, onto a PMP plastic beaker to give, after evaporation of the water at ˜20° C., a dry film with a basic weight of 1.0 g/m². By using a small piece of two-sided tape to cover the film and a wax-paper to cover the tape, and then by pressing the wax-paper-tape-film for a few seconds, the film was peeled off with the bottom side of the film on the top of the tape-wax-paper. The wax-paper was carefully removed and the film-tape was stuck to a glass slide used for the water contact angle measurement. The water contact angle and the standard deviation of the bottom side of the film is 87.2±1.8°.

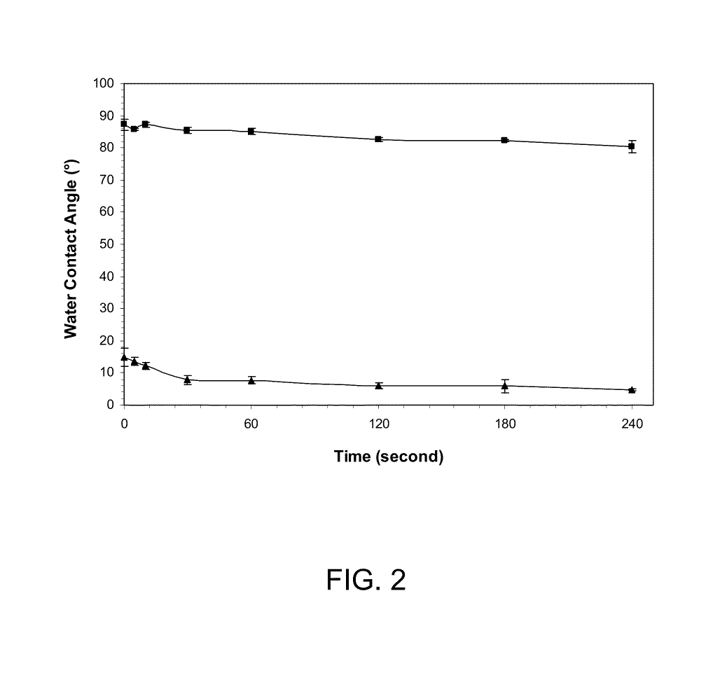

The time dependence of the water contact angle on the bottom side of this film, and the time dependence of the water contact angle on the bottom side of the film formed using Glass Petri dish as the solid support and described in Example 1 are shown in FIG. 2. The figure shows that the water contact angle of the bottom side of the film formed using PMP as the solid support material is 80.4±1.9° after four minutes (240 seconds) of contact with the water; this compared to 4.8±0.2° for the bottom side of the film formed using Glass Petri dish as the solid support material.

### EXAMPLE 3

20 ml of 0.05% CF suspension was drop-casted, according to General Procedure A disclosed above, onto a plastic beaker made of poly(propylene) (PP) to give, after evaporation of the water at ˜20° C., a dry film with a basic weight of 5.0 g/m². The average water contact angle and the standard deviation of the bottom side of the film is 67.3±11.5°. The average water contact angle and the standard deviation of the top side of the film is 22.8±3.8°. The difference in the water contact angles of the bottom and the top sides of the film formed using PP as the solid support material is 44.5°. PP is capable of inducing the formation of a cellulose film with one less hydrophilic surface and one hydrophilic surface.

### EXAMPLE 4

The potential use of the cellulose film produced according to the present invention for packaging application is illustrated in this example.

A handsheet (60±1.0 g/m²) from a northern bleached softwood kraft (NBSK) pulp was prepared according to the procedure described in PAPTAC Test Methods, Standard 0.5. Another handsheet was prepared according to the same procedure except that before the second, 2.5-minute pressing of the film, a sample of the cellulose film prepared using PMP as the solid support and described in Example 1 was placed on top of, with the top side of the film against, the NBSK sheet, to allow after the second, 2.5-minute pressing, the bottom side of the said cellulose film to be on top of the NBSK sheet. After drying the handsheets in a constant temperature and humidity room overnight, the water contact angles of the sheets were measured. The water contact angle and the standard deviation of the NBSK sheet so adhered with the cellulose film produced according to the present invention is 79.5±4.5°. The water contact angle of the NBSK sheet without the said cellulose film adhered to is 0°. These data show that the hydrophilicity of a sheet made from bleached pulp fibres such as NBSK fibres can be dramatically reduced by applying a cellulose film of the present invention onto the surface of the sheet.

In a separate experiment, another handsheet was prepared according to the same procedure except that before the second, 2.5-minute pressing of the sheet, a sample of the cellulose film prepared using PMP as the solid support and described in Example 1 was placed on top of, with the bottom side of the film against, the NBSK sheet, to allow after the second, 2.5-minute pressing, the top side of the said cellulose film to be on top of the NBSK sheet. After drying the handsheet in a constant temperature and humidity room overnight, the water contact angle of the sheet was measured. The water contact angle and the standard deviation of the NBSK sheet so adhered with the cellulose film produced according to the present invention, as expected, is only 13.9±5.3°.

All these data show that the low hydrophilicity of the bottom side of a cellulose film produced according to the present invention or the hydrophilicity of the top side of the said film can be transferred to sheets made from bleached pulp fibres, depending on whether the top side or the bottom side of the film was placed against the sheet.

### EXAMPLE 5

40 ml of 1.0% sodium carboxymethylcellulose (Na-CMC) (average M_{w}=˜250,000, DS=1.2, Sigma-Aldrich) solution was drop-casted, according to General Procedure A disclosed above, onto a polystyrene (PS) Petri dish to give, after evaporation of the water at ˜20° C., a dry and transparent film with a basic weight of 200 g/m². The average water contact angle and the standard deviation of the bottom side of the film is 89.0±6.0°. The average water contact angle and the standard deviation of the top side of the film is 41.6±1.0°. The difference in the water contact angles of the bottom and the top sides of the film formed using PS as the solid support is 47.4°.

In a separate experiment, a Glass Petri dish was cleaned with a mixture of 3:1 (v/v) concentrated sulfuric acid and 30% hydrogen peroxide and then thoroughly washed with deionized water. 40 ml of the same 1.0% Na-CMC solution was drop-casted onto the clean Glass Petri dish to give, after evaporation of the water at ˜20° C., a dry and transparent film with a basic weight of 200 g/m². The average water contact angles and the standard deviations of the bottom side and the top side of the film formed using the Glass Petri dish as the solid support material are 43.7±3.8° and 38.6±0.7°, respectively. There is practically no statistical difference in the water contact angles between the bottom side and the top side of the film formed using Glass Petri dish as the solid support material.

PS is capable of inducing the formation of sodium carboxymethylcellulose film with one less hydrophilic surface and one hydrophilic surface.

### EXAMPLE 6

A CF film with 20 g/m² basic weight and a consistency of 94.4% was prepared according to General Procedure B disclosed above, except that during the pressing and the drying of the CF film, a square piece of plastic sheet (8×8 cm) made of poly(ethylene) was inserted between the steel plate and the CF film, with the edge of CF film still in contact with the stainless steel plate. Water contact angle of the CF film was measured according to General Procedure C disclosed above. The average water contact angles and the standard deviations of the side of the film that was in contact with the plastic sheet during the pressing and drying and of the side of the film that was in contact with the filter paper during the pressing and drying are 53.5±9.0° and 13.5±1.2°, respectively.

In a separate experiment, a CF film with the same basic weight and consistency was prepared according to General Procedure B disclosed above. The average water contact angles and the standard deviations of the side of the film that was in contact with the steel plate during the pressing and drying and the side of the film that was in contact with the filter paper during the pressing and drying are 32.0±3.2° and 11.3±1.3°, respectively.

The above data show that poly(ethylene) is capable of inducing the formation of a cellulose film with a less hydrophilic surface during pressing and drying of the CF film. It increases the water contact angle of the film from 32.0±3.2° to 53.5±9.0°.

### EXAMPLE 7

A wet CF film with 20 g/m² basic weight and a consistency of ˜14% was prepared according to General Procedure B disclosed above except that no pressing or drying was performed. After couching and the removal of the couch plate and the blotter, the wet CF film, together with the filter paper that was stuck to it, was placed on top of, with the side of the CF film contacting the edge of, a 200-ml beaker containing 20 mL of hexane (boiling point =68.7° C.). The filter paper was slowly removed from the CF film. The beaker, along with the wet CF film covered on its top, was placed on a heating plate and heated until the hexane started to boil. The hexane was kept boiling for 30 min during which time the wet CF film was in contact with the hexane vapour and was being dried. After cooling to room temperature (˜20° C.), the dried CF film was removed from the top of the beaker and was placed inside an oven heated to 104° C. overnight to remove any trapped hexane residue. The CF film was removed from the oven and cooled to room temperature (˜20° C.) in a desiccator. Water contact angle measurement was then performed on both sides of the CF film according to General Procedure C disclosed above. The water contact angle and the standard deviation of the side of the CF film placed against the edge of the beaker is 88.7±3.9°; while that of the other side of the CF film is 81.3±4.4°.

These data show that the vapour of the non-polar solvent—hexane is capable of not only drying the CF film, but also making the CF film less hydrophilic. It increases the water contact angle of the film from 32.0≦3.2° to 81.3≧4.4°.

### EXAMPLE 8

A CF film with 20 g/m² basic weight and a consistency of 94.4% was prepared according to General Procedure B disclosed above. A sample of the CF film was placed on top of and held-up by the stirring blades of the stirring rod of a Parr reactor (4561 Mini Reactor) that contained 10 mL of toluene (boiling point=110.6° C.) inside its 450-mL glass liner. The reactor was sealed and heated to 180° C. and kept at this temperature for 30 min. The pressure inside the reactor during the toluene vapour treatment was 10-20 psi. The reactor was then allowed to cool down to room temperature (˜20° C.) and opened. No loss of toluene during the toluene vapour treatment of the CF film inside the reactor was detected. The CF film was removed from the reactor and placed inside an oven heated to 104° C. for overnight to remove any possible toluene residue. The CF film was removed from the oven and cooled to room temperature (˜20° C.) in a desiccator. The average water contact angle and the standard deviation of the side of the CF film that was in contact with the steel plate during the pressing and drying of the film is 64.1±3.9° after the toluene vapour treatment. The average water contact angle and the standard deviation of the side of the CF film that was in contact with the filter paper during the pressing and drying is 81.2±4.2° after the toluene vapour treatment.

These data show that the vapour of the non-polar solvent—toluene is capable of making the CF film less hydrophilic. For example, it increases the water contact angle of the side of the film that was in contact with the filter paper during the pressing and drying from 11.3±1.3° (see data from Example 6) to 81.2±4.2°.

### EXAMPLE 9

A CF film with 20 g/m² basic weight and a consistency of 94.4% was prepared and treated in the same way as that disclosed in Example 8 except that hexane instead of toluene was used for the vapour treatment. The pressure during the treatment was ˜100 psi. The average water contact angle and the standard deviation of the side of the CF film that was in contact with the steel plate during the pressing and drying of the film is 87.1±6.3° after the hexane vapour treatment. The average water contact angle and the standard deviation of the side of the CF film that was in contact with the filter paper during the pressing and drying of the film is 99.4±9.1° after the hexane vapour treatment.

These data show that the vapour of hexane is capable of making the CF film hydrophobic or less hydrophilic. For example, it increases the water contact angle of the side of the film that was in contact with the filter paper during the pressing and drying from 11.3±1.3° (see data from Example 6) to 99.4±9.1°.

1. A cellulose film comprising
a cellulose filament material free of chemical modification,
wherein the film comprises at least one surface with a water contact angle θ with a value in a range from 55° to 100°.

2. The film according to claim 1, wherein the cellulose filament material derives from a dispersed aqueous suspension of cellulose filaments from a multi-pass, high consistency refining of a northern bleached softwood kraft (NBSK) pulp and/or a thermo mechanical pulp (TMP).

3. The cellulose film according to claim 2, wherein the value of the water contact angle θ is from 60° to 100°.

4. The cellulose film according to claim 2, wherein the value of the water contact angle θ is from 70° to less than 90°.

5. The cellulose film according to claim 2, wherein the value of the water contact angle θ is from 80° to less than 90°.

6. The cellulose film according to claim 2, wherein the valued of the water contact angle θ is from 85° to less than 90°.

7. A method of producing a cellulose film with at least one surface with a water contact angle (θ) in a range from 55° to 100°, the method comprising:
providing an aqueous cellulose filament suspension free of chemical modification,
contacting the suspension onto a hydrophobic support material to produce the film; and
removing water from the film.

8. The method according to claim 7, wherein the hydrophobic support material is a polymer made from at least one of an unsubstituted or substituted alkene of formula
R₁—CH═CH—R₂
wherein R₁ and R₂ are independently hydrogen (H), unsubstituted or substituted C1-C12 alkyl group, or unsubstituted or substituted C6-C14 aryl group.

9. The method according to claim 7, wherein the hydrophobic support material is a hydrophobic polymer of ethylene selected from the group consisting of poly(ethylene) (PE), low-density poly(ethylene) (LDPE), high-density poly(ethylene) (HDPE), ultra-low-density poly(ethylene) (ULDPE) and combinations thereof.

10. The method according to claim 7, wherein the hydrophobic support material is a hydrophobic polymer of propylene, CH₂═CHCH₃ or 4-methyl-1-pentene, CH₂═CHCH₂CH(CH₃)₂, or a hydrophobic co-polymer of two to three of the alkenes selected from ethylene, propylene, and 4-methyl-1-pentene (PMP).

11. The method according to claim 7, further comprising a vapour treatment of the film with a non-polar or polar aprotic solvent.

12. The method according to claim 11, wherein the non-polar solvent is at least one of toluene and hexane.

13. The method according to claim 11, wherein the polar aprotic solvent is at least one of acetone and ethyl acetate.

14. The method according to claim 7, wherein the suspension comprises a concentration of cellulose filaments in the range of 0.001% to 10.0%.

15. The method according to claim 14, wherein the concentration of cellulose filaments is in the range of 0.005% to 5.0%.

16. The method according to claim 14, wherein the concentration of cellulose filaments is in the range of 0.01% to 2.0%.

17. The method according to claim 7, wherein the suspension further comprises additives for pH and/or conductivity control.

18. The method according to claim 17, wherein the additives further comprise water-soluble compounds or water-soluble polymers selected from the group consisting of poly(methacrylic) acid and/or poly(methacrylate) sodium salt.

19. The method according to claim 18, wherein the additives have a concentration in the range of 0.0% to 10.0 wt % of the cellulose filaments.

20. The method of claim 7, wherein the removing of the water from the film by evaporating the water at ambient temperature (20° C.) or at a higher temperature (>20° C. and ≦100° C.) with or without vacuum.

21. The method according to claim 7, wherein removing the water from the film is by contacting the suspension with a permeable hydrophobic solid support material.

22. The method of claim 7, wherein the aqueous cellulose filament suspension free of chemical modification is from a multi-pass, high consistency refining of a northern bleached softwood kraft (NBSK) pulp and/or a thermo mechanical pulp (TMP).
